(19) United States
(12) Patent Application Publication
(10) Pub. No.: US 2012/0140918 A1
(43) Pub. Date: Jun. 7, 2012

(54) SYSTEM AND METHOD FOR ECHO REDUCTION IN AUDIO AND VIDEO TELECOMMUNICATIONS OVER A NETWORK

(75) Inventor: Marcus Lee Sherry, San Francisco, CA (US)

(73) Assignee: PAGEBITES, INC., Palo Alto, CA (US)

(21) Appl. No.: 13/311,342

(22) Filed: Dec. 5, 2011

Related U.S. Application Data
(60) Provisional application No. 61/420,248, filed on Dec. 6, 2010.

(51) Int. Cl. H04M 9/08

(52) U.S. Cl. 379/406.08

(57) ABSTRACT

A method and a system use an intermediate server to process the communication between two parties, so as to eliminate echoes between them. The server performs echo cancellation in a network-based voice communication system handling a large number of conversations. In one implementation, the server allocates two echo cancellation modules to each conversation, with each echo cancellation module including (a) a communication interface for communicating with a client program associated with the echo cancellation module; (b) a first buffer for storing audio data received from the client program for transmission to another echo cancellation module; (c) a second buffer for storing audio data received from the other echo cancellation module for transmitting to the associated client program; and (d) a set of filters using the audio data in both the first buffer and the second buffer to cancel echoes in the audio data in the second buffer.

### CROSS REFERENCE TO RELATED APPLICATIONS

The present application is related to and claims priority of U.S. provisional patent application (‘Provisional Patent Application’), entitled “System And Method For Echo Reduction In Audio And Video Telecommunications Over A Network,” Ser. No. 61/420,248, filed on Dec. 6, 2010. The Provisional Patent Application is hereby incorporated by reference herein in its entirety.

### BACKGROUND OF THE INVENTION

1. Field of the Invention

The present invention relates to telecommunications over a computer network; in particular, the present invention relates to quality of audio and video communication over a computer network.

2. Discussion of the Related Art

Echo cancellation has been an active area of research in telecommunications for some time. In standard telephone networks, there are generally two sources of echoes—hybrid echo, and acoustic echo. Hybrid echoes result from the electrical properties of a telephone network. Acoustic echoes arise when signals (e.g., voice communication) originating at one end of a communication channel arrive at a recipient at the other end of the communication channel, and are then retransmitted back to the originator. For instance, two people (say, persons A and B) may be speaking to each other over a voice channel (e.g., a standard telephone connection or Voice-Over-Internet-Protocol (VOIP) connection). When person A speaks, person B listens to person A's speech through Person B's speakers. If Person B's microphone is sufficiently sensitive or close to the speakers, some of this speech may be picked up by the microphone and transmitted back to person A. This is perceived by person A as an echo of his/her speech, and can be awkward and distracting. The problem is aggravated when a “hands-free” device (e.g., a speakerphone), or a personal computer with a microphone and speakers set-up, is used for the communication. In such a system, the speakers are usually not immediately next to the listener's ears, thus necessitating an amplification in output volume. This amplified volume makes it easier for the listener to hear the other party's voice, but also makes it easier for the microphone to pick up—and hence to re-transmit—the signal back to the originating party.

Existing echo-canceling systems generally depend on what is referred to as an “altruistic” algorithm. In such an algorithm, each party endeavors to prevent the other party from hearing echoes, and vice-versa. Such an algorithm works by analyzing the signal arriving at a communication device (e.g., a telephone or a personal computer) and actuated as sound through its speaker. The algorithm tries to “subtract” a retransmitted portion of the received signal from the signal that is transmitted to the other party, so as to cancel the echoes of the received voice that the other party would otherwise hear. This processing requires an amount of work that is proportional to the so-called “echo path delay” (i.e., the amount of time between the arrival of a signal at one party's speaker and the echo of that signal at the microphone). For a typical application, the echo path delay is usually in the order of milliseconds, or even less. One common algorithm for echo cancellation in such an application is the LMS (i.e., least-mean squares) filter, or its variants, such as the normalized least-mean squares (NLMS) filter. There are other adaptive algorithms that estimate the error of a signal based only on observable signals. However, for various reasons, processing using such an algorithm at the site of the echo may be either impossible or impractical.

### SUMMARY

The present invention provides a method for using an intermediate server to process the communication between two parties, so as to eliminate echoes between them. According to one embodiment of the present invention, the server performs echo cancellation in a network-based voice communication system serving many conversations. For each conversation, the server allocates two echo cancellation modules, one for each communicating client program of the conversation, with each echo cancellation module (“current echo cancellation module”) including (a) a communication interface for communicating with a client program associated with the current echo cancellation module; (b) a first buffer for storing audio data received from the client program for transmission to a second echo cancellation module; (c) a second buffer for storing audio data received from the second echo cancellation module for transmitting to the associated client program of the current echo cancellation module; and (d) a set of filters using the audio data in both the first buffer and the second buffer to cancel echoes in the audio data in the second buffer. The communication interface of each echo cancellation module may be a logical communication interface communicating with a client program over a computer network.

According to one embodiment of the present invention, the set of filters provided on the server may include a filter implementing a method for double-talk detection. The method for double-talk detection may be any one of many methods, such as the Geigel algorithm, the “Microphone-echo cross-correlation” algorithm or the “Fast Normalized Cross-correlation” algorithm. In one embodiment, a filter implementing an echo cancellation method is suspended when the double-talk detection method detects double-talk.

The present invention allows the use of any one of many echo cancellation methods, such as the “Normalized Least-mean Squares” algorithm and the “Normalized Least-mean Squares algorithm with Pre-Whitening.” In one implementation, the echo cancellation filter may have between 4,000 to 32,000 taps. Optionally, a high-pass filter may be provided to eliminate frequency components less than 300 Hz.

The set of filters on the server may be implemented in software modules. The server may be one of multiple servers, together handling a large number of associated client programs supporting many conversations.

The present invention is better understood upon consideration of the detailed description below and the accompanying drawings.

### BRIEF DESCRIPTION OF THE DRAWINGS

FIG. 1 shows system 100 which supports echo cancellation using intermediate server 101, in accordance with one embodiment of the present invention.

FIG. 2 illustrates the operation of intermediate server 101 for echo cancellation in one conversation, in accordance with one embodiment of the present invention.

FIG. 3 shows schematically the operation of echo cancellation in conjunction with a context (e.g., context 201 or context 202), in accordance with one embodiment of the present invention.

### DETAILED DESCRIPTION OF THE PREFERRED EMBODIMENTS

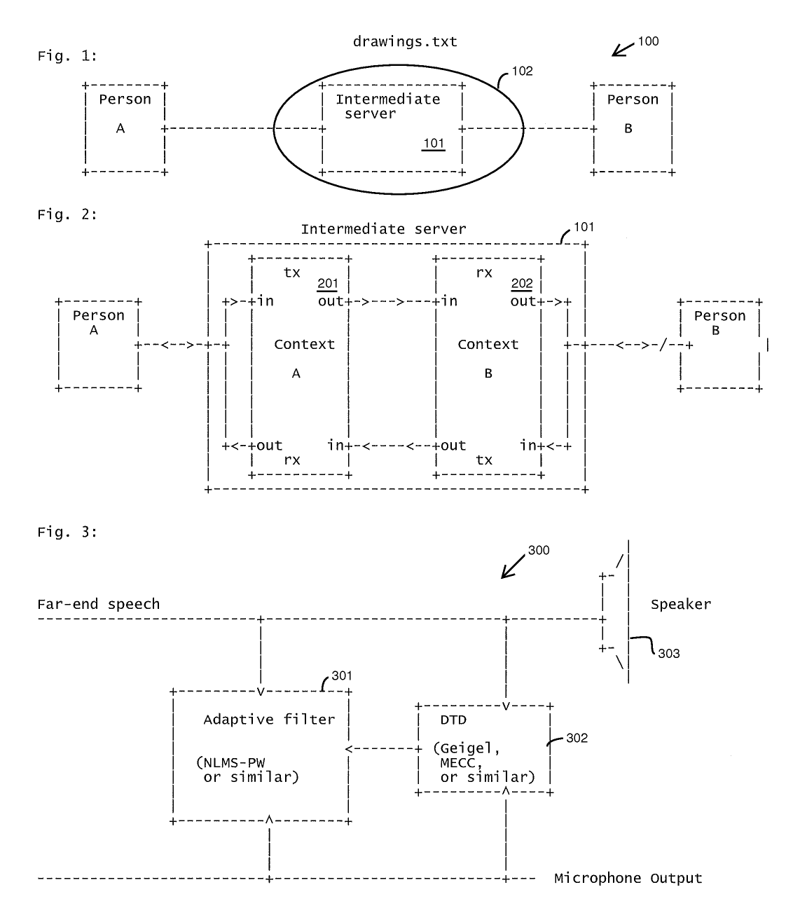

The present invention provides a method which uses an intermediate server to process video or audio communication between two parties in order to eliminate echoes between them. FIG. 1 shows system 100 which supports echo cancellation using intermediate server 101, in accordance with one embodiment of the present invention. From a user's perspective, system 100 operates as follows:
(a) the communicating parties (e.g., persons A and B) each sign into an application program that allows audio or video communication to be conducted between the parties (e.g., a website, an application program on a “smartphone,” or any other application program that provides a voice communication service).
(b) one of the parties (say, person A) initiates a conversation with the other party, which is transparently routed by the application program through intermediate server 101 to the application program associated with the other party (i.e., party B) over computer network 102;
(c) intermediate server 101 processes the audio data of the conversation, transparently removing echoes on each side, so that each party only hears the other party's speech, without interference from echoes of his/her own speech retransmitted by the other party's microphone over computer network 102.

FIG. 2 illustrates the operation of intermediate server 101 for echo cancellation, in accordance with one embodiment of the present invention. One common method for transmitting video or audio data on the web is via the Adobe Flash software from Adobe Systems, Inc. Other transmission methods are, of course, possible. Clients using such software share some initial data with each other (either directly or through an intermediary) to identify or authenticate himself/herself with each other and with the server (e.g., intermediate server 101 of FIG. 1). Thereafter, the parties may start streaming audio or video data to each other through intermediate server 101.

If both parties use, for example, the Adobe Flash software, the voice or audio data would arrive at intermediate server 101 in the Adobe Flash video format. The present invention is not limited by any particular audio or video data format. That is, if another software is used, the video or audio format may be in a format that is specific or proprietary to the transmitting software. In that situation, according to one embodiment of the present invention, the received video or audio data may be transformed (or transcoded) into a representation that is compatible with—or which is convenient for—the echo cancellation algorithm. One such format may be pulse-code modulation (PCM). Under the PCM format, analog audio data is sampled at regular intervals (e.g., 8 kHz, or 8,000 samples per second, which is typical for an audio communication application), and each sample is given a value within a certain range (e.g., a typical range may be a 16-bit range, or from −32,768 to 32,767).

As shown in FIG. 2, within intermediate server 101, each party of the conversation is associated with an echo cancellation module or “context” (e.g., context 201 or context 202) which contains information about the audio data recently transmitted (“tx data”) and received (“rx data”) by each party. The audio data may include voice or speech data. For person A, for example, context 201 includes transmitted audio data from a microphone at person A's location (labeled “tx” data) received into context 201 over a “tx in” input port. Context 201 also includes audio data received from a microphone at person B's location (labeled “rx” data) received over an “rx in” input port from context 202. Similarly, context 202 includes transmitted audio data from a microphone at person B's location (likewise labeled “tx” data) received over a “tx in” input port. Context 202 also includes received audio data from a microphone at person A's location (likewise, labeled “rx” data) received from context 201 over a “rx in” input port. Rx data in context 201 is provided over “rx out” port to a speaker system in person A's location. Similarly, the rx data in context 202 is provided to a speaker system at person B's location. In other words, each context has access to the audio data from both parties in the conversation. In some applications, intermediate server 101 may first transcode incoming audio data into a format suitable for use in echo cancellation contexts 201 and 202, and then transcode the output of echo cancellation contexts 201 and 202 back into a format suitable for network streaming.

Initially, context 201 accumulates audio data coming from person B (received through

Context 201's “rx in” port) for a time period. The accumulated data may be buffered internally and simultaneously transmitted to person A without modification by context 201. When audio data is received at context 201's “tx in” port (i.e., when person A speaks), context 201 may modify such tx data before sending it through the “tx out” port to context 202 and hence to a speaker system at Person B's location. The decision as to whether or not to modify the incoming tx data may be based on a determination as to whether or not person A is currently speaking. If person A is determined to be speaking, context 201 generally sends the tx audio data unmodified to context 202. However, when context 201 determines that person A is not speaking, and yet receives audio data from person A, such audio data may include an echo of person B's speech, and therefore should be canceled.

FIG. 3 shows schematically process 300 for echo cancellation in conjunction with a context (e.g., context 201 or context 202), in accordance with one embodiment of the present invention. Echo cancellation process 300 include a pluggable double-talk detection method. Double-talk detection (DTD) module 302 determines whether both parties are speaking at the same time (“double talk”). Conventional echo cancellation techniques often fail to converge properly when the signal arriving at the microphone is a mixture of more than one speaking person (rather than just the echo of one person speaking, for example), and echo-cancellation must be suspended during periods of double-talk. To detect a double-talk situation, DTD module 302 analyzes the audio data received by the context through its “rx in” port by correlating the rx data with the audio data received through the “tx in” port.

Any one of many known DTD algorithms may be used to implement DTD module 302. For example, the Geigel algorithm is known and used in conventional telephone networks. The Geigel algorithm performs well in situations where the echo path is known and the delay is more or less constant (e.g., in a telephone network with a fixed line delay). However, the Geigel algorithm performs poorly for situations involving unpredictable or variable-length echo paths. As DTD is an area of active research, making DTD module 302 pluggable (i.e., in such a modular form that it can be replaced easily with a recompilation or with a command-line switch) allows echo cancellation process 300 to take advantage of ongoing developments in this field. Other suitable DTD algorithms that may be used to implement DTD module 302 include the “Microphone-echo cross-correlation” algorithm and the “Fast Normalized Cross-correlation” algorithm.

Once it is determined that echo cancellation should take place, the context again uses its buffered samples received through the “rx in” port. First, optional filtering on the “tx in” audio data may be performed. For instance, as a result of limitations in the conventional telephone network, telephone users are accustomed to the absence of frequencies in the transmitted speech below 300 Hz in voice communications. Such optional filtering (not shown in FIG. 3) can be emulated using a digital filter, such as a properly-configured finite impulse response filter. After filtering the “tx in” audio signal, a standard echo cancellation algorithm can be applied. One such algorithm, which may be implemented as an adaptive filter (e.g., adaptive filter 301), may be the Normalized Least-mean Squares algorithm with Pre-Whitening (“NLMS-PW”). The NLMS-PW algorithm is a variant of the standard NLMS algorithm, performing a first “whitening” step on the incoming signal, so as to make its spectrum resemble “white noise” (i.e., to make the signal have equal power within a fixed bandwidth of any center frequency). The whitening is done because NLMS-type algorithms converge best with white noise-like input signals, but normal human speech does not resemble white noise. Adaptive filter 301 may be implemented, for example, by an infinite-impulse response high-pass filter with appropriate coefficients.

The complexity of an implementation of the NLMS or NLMS-PW algorithm is generally proportional to the echo path delay, as previously mentioned. For a conventional application (e.g., a conventional telephone system), the echo path delay may only be a few milliseconds. For the server-based approach (e.g., system 100 illustrated in FIGS. 1 and 2), however, the delay between a signal leaving the “rx out” port of the echo cancellation context (e.g., context 201 or context 202) to the speakers at a participant's location, and returning to the “tx in” port through a microphone at the participant's location can be much longer, since the echo path delay depends at least in part on the network delay between the person connected to the context and intermediate server 101. Network delays of 200 milliseconds are not uncommon, and hence, the echo cancellation algorithms must be prepared to handle such delays as well. The NLMS filter therefore should have enough taps to handle 200 ms of delay—for an 8,000 Hz sample rate, such a filter requires 16,000 taps. Such a filter is expensive from a hardware and processing resources standpoint, even on dedicated digital signal processing (DSP) hardware. However, such a result can be achieved with a combination of suitably optimized programming techniques and parallelization—e.g., running the code on many servers simultaneously, with each server handling a fraction of the total number of conversations taking place. Additionally, if the echo path delay can be accurately determined, the number of taps can be adjusted accordingly in order to reduce the amount of computation required. In one implementation, a filter of the present invention can be implemented using a filter with 4,000-32,000 taps.

The above detailed description is provided to illustrate the specific embodiments of the present invention and is not intended to be limiting. Many variations and modifications within the scope of the present invention are possible. The present invention is set forth in the following claims.

1. A server for echo cancellation in a network-based voice communication system handling multiple conversations, comprising:
for each conversation, a first echo cancellation module and a second echo cancellation module, each echo cancellation module comprising:
a communication interface for communicating with a client program associated with the echo cancellation module;
a first buffer for storing audio data received from the client program for transmission to the other echo cancellation module;
a second buffer for storing audio data received from the other echo cancellation module for transmitting to the associated client program; and
a set of filters using the audio data in both the first buffer and the second buffer to cancel echoes in the audio data in the second buffer;
wherein the first communication interface is associated with a first client program over a computer network, and the second communication interface is associated with a second client program over the computer network.

2. The server of claim 1, wherein the set of filters comprise a filter implementing a method for double-talk detection.

3. The server of claim 2, wherein the method for double-talk detection is selected from the group consisting of: the Geigel algorithm, the “Microphone-echo cross-correlation” algorithm and the “Fast Normalized Cross-correlation” algorithm.

4. The server of claim 2, wherein the set of filters further comprises a filter implementing an echo cancellation method that is suspended when the double-talk detection method detects double-talk.

5. The server of claim 1, wherein the set of filters comprises an echo cancellation filter implementing an echo cancellation method.

6. The server of claim 5, wherein the echo cancellation method is selected from the group consisting of the “Normalized Least-mean Squares” algorithm and the “Normalized Least-mean Squares algorithm with Pre-Whitening.”

7. The server of claim 5, wherein the echo cancellation filter has between 4,000 and 32,000 taps.

8. The server of claim 5, further comprising a filter for eliminating frequency components less than 300 Hz.

9. The server of claim 1, wherein the server is one of multiple servers together handling a number of associated client programs greater than three.

10. A method for performing echo cancellation in a network-based voice communication system handling multiple conversations, comprising:
in a server having allocated a first echo cancellation module and a second echo cancellation module for each conversation, performing in each of the echo cancellation modules:
communicating with a client program associated with the echo cancellation module to receive into a first buffer audio data received from the client program for transmission to the other echo cancellation module and to receive into a second buffer audio data received from the other echo cancellation module for transmitting to the associated client program; and
using a set of filters to filter audio data in both the first buffer and the second buffer to cancel echoes in the audio data in the second buffer;
wherein the communication interface of the first echo cancellation module is associated with a first client program over a computer network, and the communication interface of the second echo cancellation module is associated with a second client program over the computer network.

11. The method of claim 10, further comprising performing a method for double-talk detection in the set of filters.

12. The method of claim 11, wherein the method for double-talk detection is selected from the group consisting of: the Geigel algorithm, the “Microphone-echo cross-correlation” algorithm and the “Fast Normalized Cross-correlation” algorithm.

13. The method of claim 10, further comprising implementing an echo cancellation method in the set of filters, wherein the echo cancellation method is suspended when the double-talk detection method detects double-talk.

14. The method of claim 10, further comprising an echo cancellation filter in the set of filters for implementing an echo cancellation method.

15. The method of claim 14, wherein the echo cancellation method is selected from the group consisting of the “Normalized Least-mean Squares” algorithm and the “Normalized Least-mean Squares algorithm with Pre-Whitening.”

16. The method of claim 14, wherein the echo cancellation filter has between 4,000 and 32,000 taps.

17. The method of claim 14, further comprising providing a filter for eliminating frequency components less than 300 Hz.

18. The method of claim 10, wherein the server is one of multiple servers together handling a number of associated client programs greater than three.
